(19) United States
(12) Patent Application Publication
(10) Pub. No.: US 2011/0085205 A1
(43) Pub. Date: Apr. 14, 2011

(54) IMAGE FORMING APPARATUS AND PROCESSING CONTROL METHOD

(75) Inventor: Takaharu Ouchi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/902,414

(22) Filed: Oct. 12, 2010

Related U.S. Application Data
(60) Provisional application No. 61/251,541, filed on Oct. 14, 2009.

(51) Int. Cl. G06F 3/12

(52) U.S. Cl. 358/1.15

(57) ABSTRACT

An image forming apparatus includes: a detection unit which detects connection of an external storage device; a determination unit which acquires path information of one or plural files in the external storage device that is detected as being connected, by the detection unit, and determines which hardware unit should be started up on the basis of the path information; a startup unit which starts up a hardware unit corresponding to the determination by the determination unit; and a processing execution unit which executes processing to the file, using the hardware unit started up by the startup unit.

### CROSS-REFERENCE TO RELATED APPLICATION

This application is based upon and claims the benefit of priority from: U.S. provisional application 61/251,541, filed on Oct. 14, 2009; the entire contents all of which are incorporated herein by reference.

### FIELD

Embodiments described herein relate generally to an image forming apparatus that can be connected to an external storage device.

### BACKGROUND

An image forming apparatus is known which operates in a power-saving mode when the apparatus is not used for a predetermined period and which returns and starts up when necessary, in order to reduce power consumption. Also, an image forming apparatus is known which has a terminal to be connected with an external storage device such as a USB (universal serial bus) memory or USE hard disk drive and which prints data in the external storage device or transmits the data to outside, or scans a paper document and stores the scanned data in the external storage device.

When power is supplied to hardware units that are not used for processing, such as when the apparatus returns from the power-saving mode, power is consumed accordingly. Some hardware units take quite a long time to be in a normally available state and the user has to wait until the startup of the hardware units is completed.

### DESCRIPTION OF THE DRAWINGS

FIG. 1 schematically shows an image forming apparatus.

FIG. 2 shows the hardware configuration of the image forming apparatus according to the embodiment.

FIG. 3 shows functional blocks in the image forming apparatus according to the embodiment.

FIG. 4A is a flowchart showing processing in Example 1 (Part 1).

FIG. 4B is a flowchart showing processing in Example 1 (Part 2).

FIG. 5A and FIG. 5B show an example of display by a UI unit according to the embodiment.

FIG. 6 is a flowchart showing the operation at the time of automatically creating a folder according to the embodiment.

FIG. 7 shows an example of display at the time of automatically creating a folder according to the embodiment.

FIG. 8A is a flowchart showing processing in Example 2 (Part 1).

FIG. 8B is a flowchart showing processing in Example 2 (Part 2).

### DETAILED DESCRIPTION

In general, according to an embodiment, an image forming apparatus includes a detection unit, a determination unit, a startup unit, and a processing execution unit. The detection unit detects connection of an external storage device. The determination unit acquires path information of one or plural files in the external storage device that is detected as being connected, by the detection unit, and determines which hardware unit should be started up on the basis of the path information. The startup unit starts up a hardware unit corresponding to the determination by the determination unit. The processing execution unit executes processing to the file, using the hardware unit started up by the startup unit.

Hereinafter, an embodiment will be described with reference to the drawings.

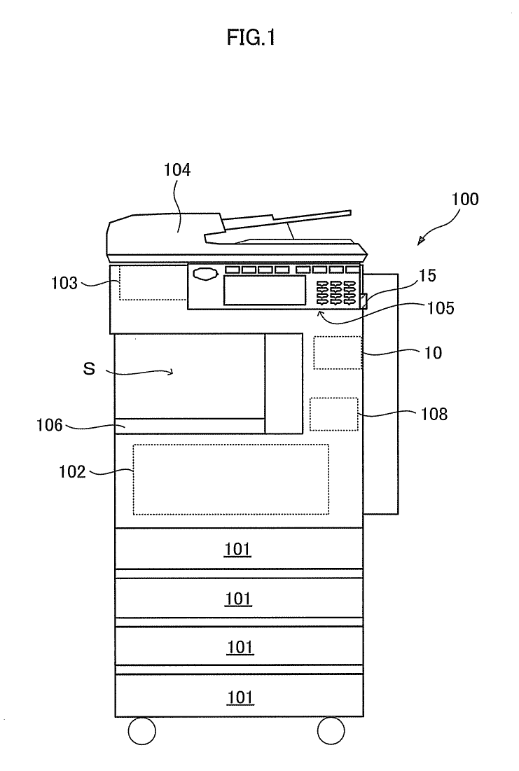

An image forming apparatus (MFP or multi-function peripheral) will be described with reference to FIG. 1. FIG. 1 is a front view schematically showing the image forming apparatus.

An image forming apparatus 100 has plural paper supply cassettes 101. Each paper supply cassette 101 houses plural sheets. The plural sheets housed in each paper supply cassette 101 pass a sheet carrying path and are supplied to a printer unit 102. The printer unit 102 forms a developer image on the sheets on the basis of image data. The image data includes, for example, image data transmitted from an external device (for example, a personal computer) to the image forming apparatus 100 or image data generated through scanning by a scanner unit 103.

The scanner unit 103 scans an image on a sheet document or book document and thus generates image data. A device (ADF or automatic document feeder) 104 which automatically carries the document to the scanner unit 103 is provided above the scanner unit 103.

In an upper part of the image forming apparatus 100, there is a control panel 105 for inputting various kinds of information to the image forming apparatus 100. The control panel 105 can include, for example, button switches or a touch panel.

The printer unit 102 forms an electrostatic latent image corresponding to image data, on a photoconductive surface of a photoconductive member, and then supplies a developer to form a developer image. The printer unit 102 transfers the developer image formed on the surface of the photoconductive member to a sheet. The developer image can be transferred to the sheet as the sheet is made to contact the surface of the photoconductive member. After the developer image on the photoconductive member is transferred to an intermediate transfer belt, the developer image can be transferred from the intermediate transfer belt to the sheet.

The developer image transferred to the sheet is fixed to the sheet by heating. The sheet to which the developer image is fixed passes the sheet carrying path and moves to a sheet discharge space S. A sheet discharge tray 106 for stacking sheets is provided in the sheet discharge space S.

The image forming apparatus 100 also has a power source unit 108 and a system unit 10. These units will be described later.

In the configuration shown in FIG. 1, the scanner unit 103 is provided in the image forming apparatus 100 as a digital multi-function peripheral. However, the embodiment can also be applied to a case where a scanner is provided in an image forming apparatus as a digital copier or a case where a product is made up of a scanner alone. The embodiment can also be applied to an ink jet image forming apparatus which forms an image by ejecting ink.

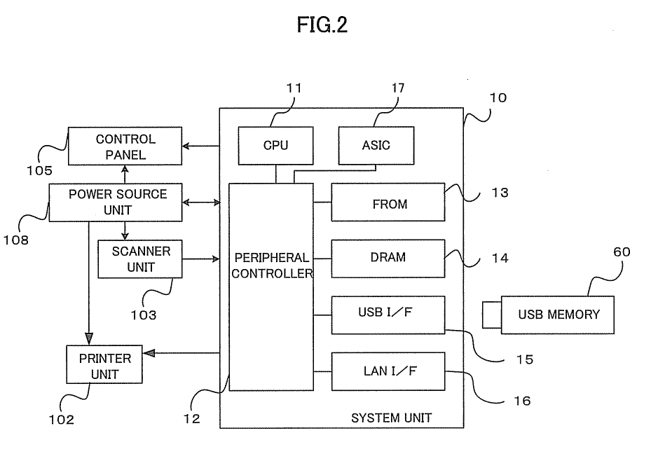

FIG. 2 shows the hardware configuration of the image forming apparatus 100 (mainly the configuration within the system unit 10) that is necessary to carry out the embodiment. A program which causes the image forming apparatus 100 to operate is stored in an FROM (flash read only memory) 13. A CPU (central processing unit) 11 decrypts and executes the program and thereby controls the image forming apparatus 100. The arithmetic operation for executing the program is carried out using a DRAM (dynamic random access memory) 14.

An ASIC (application specific integrated circuit) is a processing circuit which can execute predetermined processing. The ASIC 17 executes various kinds of processing in the image forming apparatus 100.

The control panel 105, and various input-output ports such as a USB interface 15 and a LAN (local area network) interface 16 are controlled by a peripheral controller 12. Power supply to the scanner unit 103, the printer unit 102, the control panel 105, and each interface in the system unit 10 is carried out by the power source unit 108 and controlled by the CPU 11. A USB memory 60 is used for storing scanned data at the time of scanning or for storing print data. The USB memory 60 is connected to the image forming apparatus 100 via the USB interface 15.

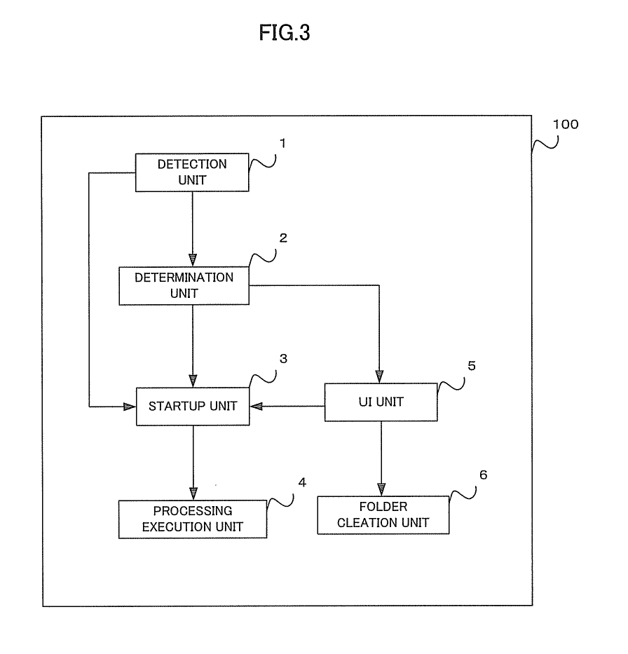

Next, FIG. 3 shows an example of functional blocks according to the embodiment. The image forming apparatus 100 has a detection unit 1, a determination unit 2, a startup unit 3, a processing execution unit 4, a UI (user interface) unit 5, and a folder creation unit 6. The operation contents of these functional blocks will be described later with reference to the flowcharts.

Here, the correspondence between each functional block shown in FIG. 3 and the hardware configuration shown in FIG. 2 will be described. The detection unit 1 is realized as the CPU 11, the peripheral controller 12, the USE interface 15, a USE-related driver (program) in the FROM 13, and the DRAM 14 cooperate with each other. The determination unit 2 is realized as the CPU 11, the USB interface 15, the peripheral controller 12, the DRAM 14, and a determination program in the FROM 13 cooperate with each other. The startup unit 3 is realized as the CPU 11, the power source unit 108, the DRAM 14, a driver and power supply control program in the FROM 13 to control the power source unit 108, and the peripheral controller 12 cooperate with each other.

The processing execution unit 4 is realized as the CPU 11, the scanner unit 103, the printer unit 102, the DRAM 14, the USB interface 15, the LAN interface 16, and a driver in the FROM 13 to control these hardware units cooperate with each other. The UI unit 5 is realized as the CPU 11, the DRAM 14, the control panel 105, the USB interface 15, the peripheral controller 12, and a driver in the FROM 13 to control these hardware units cooperate with each other. The folder creation unit 6 is realized as the CPU 11, the peripheral controller 12, the USB interface 15, the DRAM 14, and a folder creation program in the FROM 13 cooperate with each other.

### EXAMPLE 1

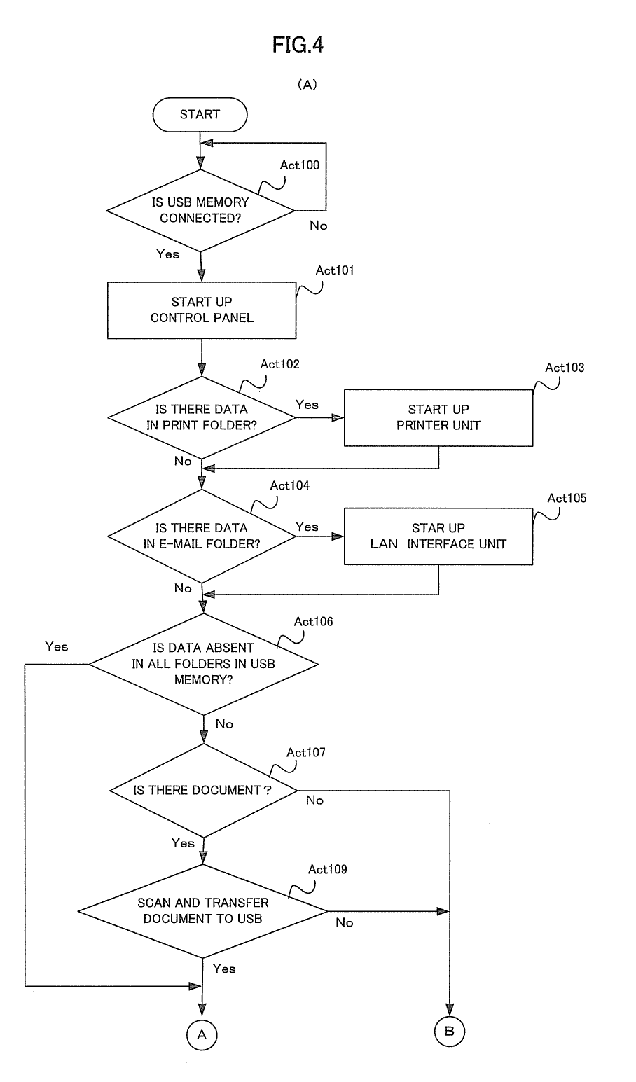

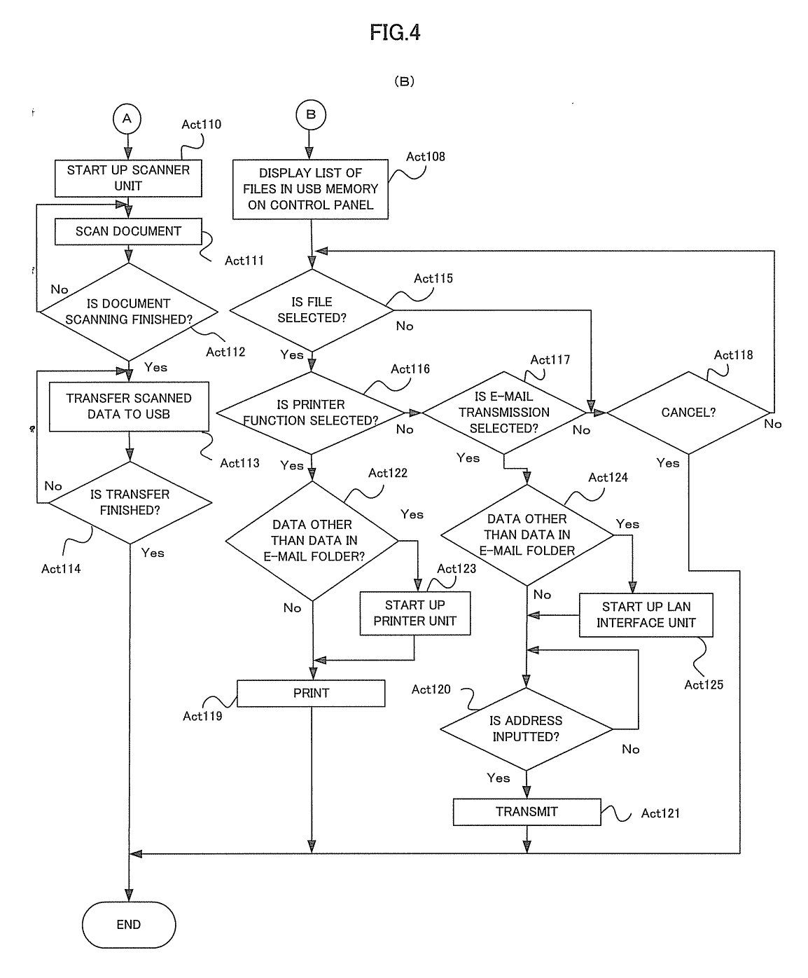

Hereinafter, the operation of the functional blocks using the above hardware units will be described. FIG. 4A and FIG. 4B are flowcharts showing an example of the operation (Example 1) of the image forming apparatus 100. The flowcharts start with the state where the image forming apparatus 100 is in the power-saving mode.

The detection unit 1 detects that the USB memory 60 is connected to the USB interface 15 (ACT 100). The startup unit 3 resumes power supply to the control panel 105 (ACT 101). The determination unit 2 determines whether there is image data in a print folder in the USB memory 60 (ACT 102). This folder is a folder to store image data that should be printed. Its folder name may be fixedly decided or may be set by the user. In the case of fixedly deciding a folder name, the development manufacturer may define a folder name in advance and write “By creating a folder XXX in a USB memory and saving print data there, you can reduce the restoration time from the power-saving mode” in a user's manual or the like. Thus, the manufacturer can notify the user of the folder name. When there is image data in the print folder (Yes in ACT 102), the startup unit 3 starts up the printer unit 102 (ACT 103) (in this embodiment, startup means supplying power to make a hardware unit available for normal use). When there is no image data (No in ACT 102), the processing shifts to ACT 104.

Next, the determination unit 2, similarly to ACT 102, determines whether there is image data in an email folder (ACT 104). This folder is a folder to store image data that should be transmitted via email. Its folder name may be fixedly decided or may be set by the user. In the case of fixedly deciding a folder name, the development manufacturer may define a folder name in advance and write “By creating a folder XXX in a USB memory and saving email transmission data there, you can reduce the restoration time from the power-saving mode” in a user's manual or the like. Thus, the manufacturer can notify the user of the folder name. When there is image data in the email folder (Yes in ACT 104), the startup unit 3 starts up the LAN interface 16 (ACT 105). When there is no image data (No in ACT 104), the processing shifts to ACT 106.

The determination unit 2 determines whether there is a processible file in any folder in the USB memory 60 including the print folder and the email folder (ACT 106). When there is a processible file in the USB memory 60 (No in ACT 106), the processing shifts to ACT 107. When there is no file (Yes in ACT 106), the processing shifts to ACT 110 on the assumption that a document is scanned and the function of transferring image data of the document into the USB memory 60 is used.

The determination unit 2 determines whether there is a document in the scanner unit 103 (ACT 107). The determination unit 2 determines that there is a document, for example, when a document installed in the ADF 104 is detected by a sensor of the ADF 104 or when the installment of a document is detected by a sensor of the scanner unit 103. When there is a document in the scanner unit 103 (Yes in ACT 107), the processing shifts to ACT 109. When there is no document (No in ACT 107), the UI unit 5 acquires a file in a folder held in the USB memory 60 and displays the file on the control panel 105 (ACT 108). When there is a document (Yes in ACT 107) and the user does not scan a document and does not select the transfer function to the UBS memory 60 (No in ACT 109), the UI unit 5 displays a list of folders and files in the USB memory 60 and thus prompts the user to select a file (ACT 108).

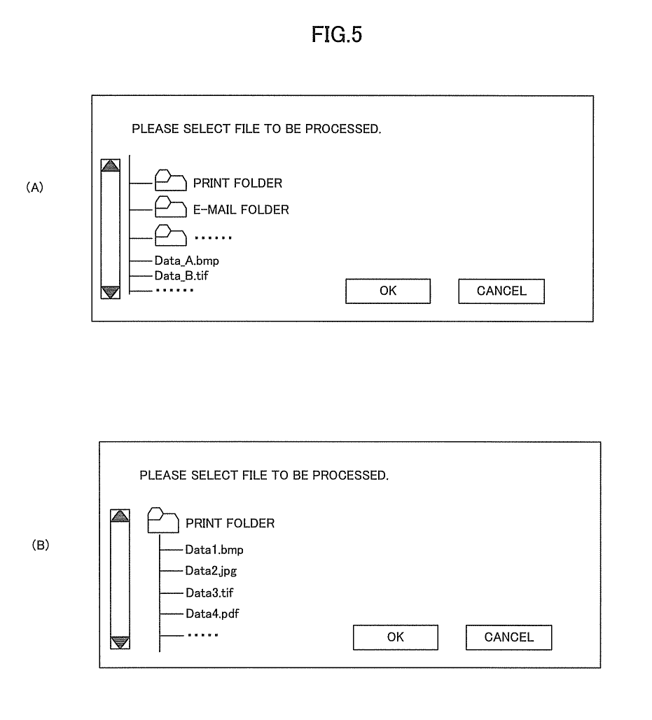

FIG. 5A and FIG. 5B show an example of display by the UI unit 5 in this case. On the control panel 105, first, a file or folder located on the uppermost layer is displayed (see FIG. 5A). When the folder on this upper layer is selected via the touch panel, a file or folder in the selected folder is displayed (see FIG. 5B). When there is a print folder or email folder, a list of files or folders in these folders may be displayed directly (see FIG. 5B). As the UI unit 5 shows a display in this manner, a specific file is selected by the user except for the case of cancelation.

Meanwhile, when the transfer function is selected by the user (Yes in ACT 109), the startup unit 3 starts up the scanner unit 103 (ACT 110). The processing execution unit 4 uses the scanner unit 103 to scan the document, outputs image data of the document to the system unit 10, and stores the image data in the DRAM (ACT 111, ACT 112). After the scanning of the document is finished (Yes in ACT 112), the processing execution unit 4 transfers the image data existing in the DRAM 14 to the USB interface 15 (ACT 113). The USB interface 15 converts the transferred data to data conforming to the USE standard and sends the converted data to the USB memory 60 (ACT 114).

The processing after ACT 108 will now be described. After the data in the USB memory 60 is displayed (ACT 108), the UI unit 5 determines whether the displayed file is selected (ACT 115). When the file is not selected (No in ACT 115), the UI unit 5 determines whether cancelation is selected (ACT 118). In the case of cancelation (Yes in ACT 118), the processing ends. When cancelation is not selected (No in ACT 118), the UI unit 5 waits for the user to select the file (return to ACT 115).

Meanwhile, when the displayed file is selected in ACT 115 (Yes in ACT 115) and the UI unit 5 determines that the printer function is selected (Yes in ACT 116), the UI unit 5 then determines whether the selected file is a file other than a file in the print folder or not (ACT 122). When the selected file is a file other than a file in the print folder (Yes in ACT 122), the printer unit 102 is yet to be started up at this point and therefore the startup unit 3 starts up the printer unit 102 (ACT 123). The processing then shifts to ACT 119. When the selected file is a file in the print folder (No in ACT 122), the startup of the printer unit 102 is already completed by ACT 103 and therefore the processing immediately shifts to ACT 119. The processing execution unit 4 reads out the selected file from the UBS memory 60 and accumulates the read-out file in the DRAM 14. After that, the processing execution unit 4 outputs the accumulated data to the printer unit 102, thus starting printing (ACT 119).

When the printer function is not selected (No in ACT 116) and the email function is selected (Yes in ACT 117), the CPU 11 stores the file data selected by the user from the USB memory 60, into the DRAM 14. Next, the UI unit 5 determines whether the selected file is a file other than a file in the email folder or not (ACT 124). When the selected file is a file other than a file in the email folder (Yes in ACT 124), the LAN interface 16 is yet to be started up at this point and therefore the startup unit 3 starts up the LAN interface 16 (ACT 125). The processing shifts to ACT 120. When the selected file is a file in the email folder (No in ACT 124), the startup of the LAN interface 16 is already completed by ACT 105 and therefore the processing immediately shifts to ACT 120. The UI unit 5 waits for the user to input the email address of the transmission destination (ACT 120). After the address is inputted (Yes in ACT 120), when transmission is selected by the user, the processing execution unit 4 transmits the file data in the DRAM 14 selected by the user, to the LAN interface 16 (ACT 121). The processing then ends.

### APPLICATION 1 OF EXAMPLE 1

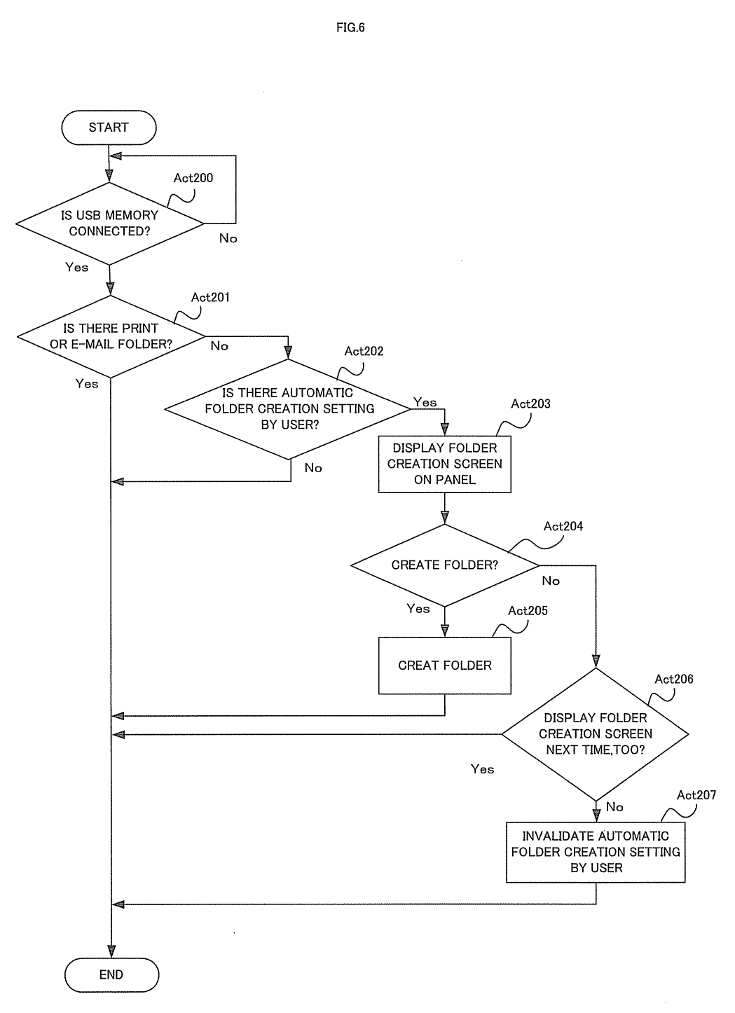

In the above example, it is described that the folders to save print data and email transmission data maybe fixed or variable. However, when the folder name is fixed and the fixed folder does not exist in the UBS memory, the user no longer needs to create a folder in the USB memory by using the following technique. FIG. 6 is a flowchart illustrating the processing to realize this case. Here, in this example, the user's log-in to the image forming apparatus 100 and authentication of the user are already finished.

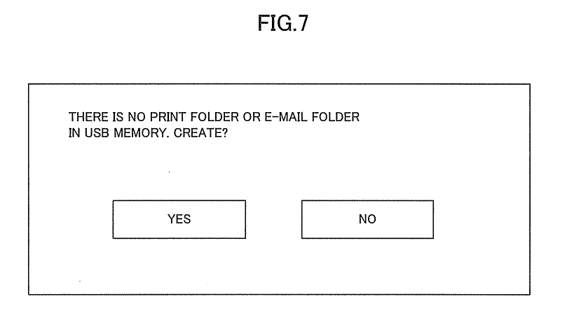

When the connection of the USB memory 60 is detected by the detection unit 1 (Yes in ACT 200), the determination unit 2 determines whether there is a print folder and an email transmission folder in the USB memory 60 (ACT 201). Here, when both exist (Yes in ACT 201), the processing immediately ends. When these folders do not exist (No in ACT 201), the determination unit 2 confirms whether the automatic folder creation setting by the user operating the apparatus is valid (ACT 202). When the setting is invalid (No in ACT 202), the processing ends. Normally, in a system where user authentication is performed, there is a database in which related information for each user is saved, and therefore an item “automatic folder creating setting” may be prepared in advance as related information. When the automatic folder creation setting is valid (Yes in ACT 202), the UI unit 5 displays a folder creation screen on the control panel 105 (ACT 203), thus letting the user select whether to create a folder. FIG. 7 shows an example of the display on the control panel 105 at this time.

When “Yes” is selected on the control panel 105 (Yes in ACT 204), the folder creation unit 6 creates a predefined fixed folder (ACT 205) and the processing ends. When “No” is selected on the control panel 105 (No in ACT 204), the UI unit 5 displays a screen which lets the user select whether or not the folder creation screen should be displayed next time, too (ACT 206). When the option to display the folder creation screen next time, too, is selected by the user (Yes in ACT 206), the processing immediately ends. When the option of not displaying the folder creation screen is selected by the user (No in ACT 206), the folder creation unit 6 (or the processing execution unit 4) invalidates the automatic folder creation setting (ACT 207) and the processing ends.

### APPLICATION 2 OF EXAMPLE 1

As another application example, a configuration may be considered in which the processing execution unit 4 carries out printing and email transmission of all the files in the print folder and the email folder, and deletes these files after the processing (invalidates access to the files). Also, a configuration may be considered in which the processing execution unit 4 moves the processed files to another folder (for example, a processed items folder). With these configurations, the user's selection operation via the UI unit 5 is reduced. That is, as the user puts files which the user wants to print or files which the user wants to transmit, in the print folder or email folder, the file selection by the user using the UI unit is not necessary. Therefore, the image forming apparatus 100 can be configured to automatically carry out printing and email transmission, except for input of an email address, and not to reprocess files that are processed once.

### APPLICATION 3 OF EXAMPLE 1

As another application example, a case where an empty USB memory having no folder or file is connected will be described. When an empty USB memory is connected, it can be assumed that the user wants to take a document in the form of data into the USB memory because there is no file to be processed. Thus, a configuration may be considered in which when the connection of a USB memory is detected by the detection unit 1 and it is determined by the determination unit 2 that there is no folder or file, the startup unit 3 immediately starts up the scanner unit 103 (without starting up any other hardware unit).

### EXAMPLE 2

In Example 1, an example where a print folder and an email folder are used is described. Here, an example where a print keyword and an email keyword are used instead (Example 2) will be described. In Example 2, of files held in the USB memory, a file having a print keyword included in a part of its file name is processed as a file to be printed, and a file having an email keyword included in its file name is processed as a file to be transmitted via email. For example, when a print keyword “*print*” is set (where “*” represents an arbitrary letter or letter string) and a file “data.bmp” is to be printed, the file name may be changed to “*print*data.bmp” and the file may thus be saved in the USB memory with the changed name. The same applies to email transmission.

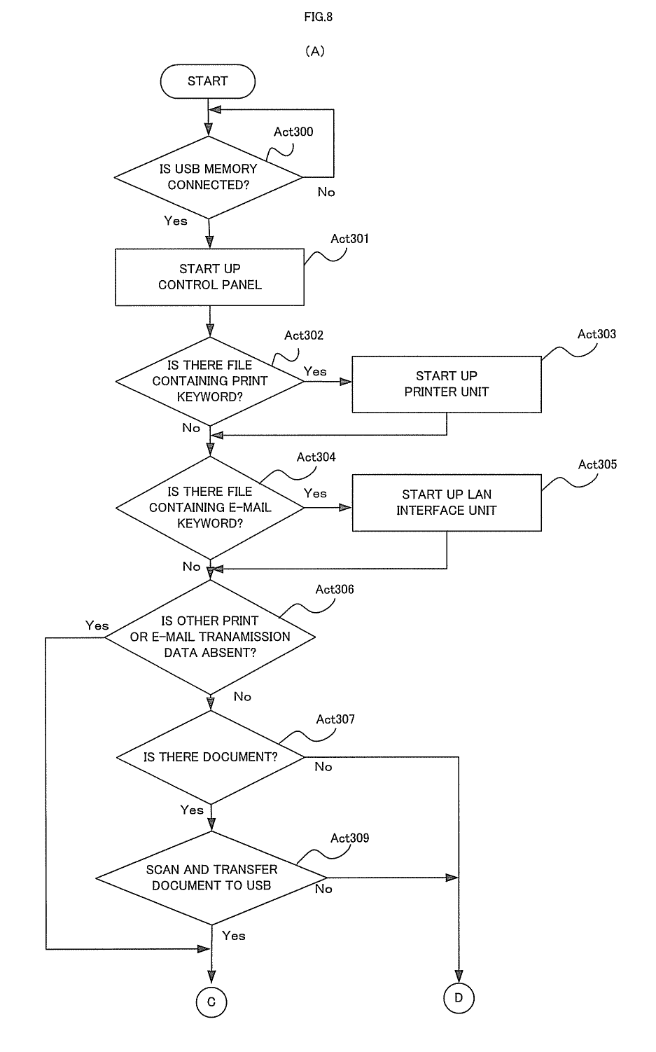

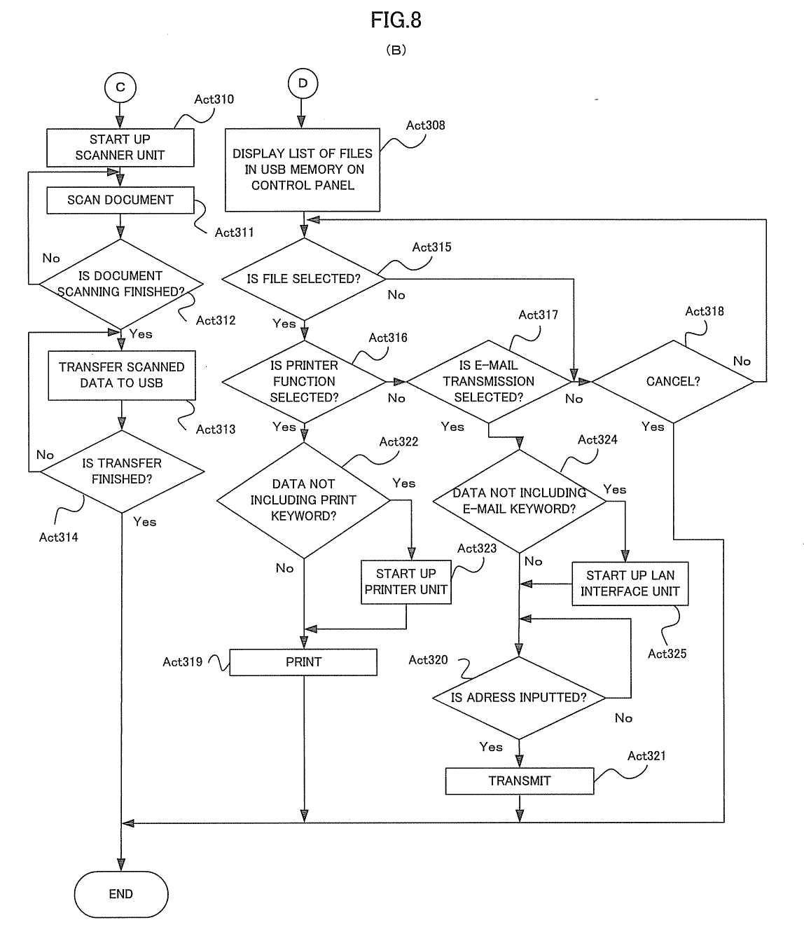

The operation to realize this processing will be described with reference to the flowchart of FIG. 8A and FIG. 8B. The flowchart shown in FIG. 8A and FIG. 8B is substantially similar to the flowchart shown in FIG. 4A and FIG. 4B. However, the processing of ACT 302, ACT 304, ACT 306, ACT 322 and ACT 324 is different. In ACT 302, search for a file including a print keyword is carried out instead of the search for a file in the print folder in Example 1. In ACT 304, search for an email keyword is carried out instead of the search for a file in the email folder. In ACT 306, a printable file other than the file searched for in ACT 302 and ACT 304, and a file that can be transmitted via email are searched for.

In ACT 322, it is determined whether the selected file is a file including a print keyword or not, instead of determining whether the selected file is a file other than a file in the print folder or not in Example 1. Similarly, in ACT 324, it is determined whether the selected file is a file including an email keyword or not, instead of determining whether the selected file is a file other than a file in the email folder or not.

### APPLICATION 1 OF EXAMPLE 2

Similarly to the above-described Example 1, a configuration may be considered in which the processing execution unit 4 processes a file including a print keyword or an email keyword in its file name and then deletes such files. Also, a configuration may be considered in which the processing execution unit 4 changes the file name after processing, for example, by adding a letter string “processed” to the file name or deleting the print keyword or email keyword from the file name. With these configurations, as a file to be printed or a file to be transmitted is given a file name including a print keyword or an email keyword, the file selection by the user using the UI unit 5 is no longer necessary. Therefore, the image forming apparatus 100 can be configured to automatically carry out printing and email transmission, except for input of an email address, and not to reprocess files that are processed once.

### APPLICATION 2 OF EXAMPLE 2

As another application example, a configuration maybe considered in which parameters designating print conditions that are necessary for printing such as the number of print copies, sheet size, and whether to perform double-side print, as well as a print keyword, are included in the file name. In this case, the determination unit 2 searches for a file including a print keyword in its file name (ACT 302), and also analyzes (resolves) the file name to acquire each parameter and sends each parameter to the processing execution unit 4 via the DRAM 14. After that, the startup unit 3 starts up the printer unit 102 (ACT 303). The processing execution unit 4 carries out processing corresponding to each parameter, using the printer unit 102 (ACT 319).

Similarly, a configuration may be considered in which the email address of a transmission destination as well as an email keyword is included in the file name. In this case, the determination unit 2 searches for a file including an email keyword in its file name (ACT 304), and also analyzes the file name to acquire the email address of the transmission destination and sends the email address to the processing execution unit 4 via the DRAM 14. After that, the startup unit 3 starts up the LAN interface 16 (ACT 305). The processing execution unit 4 carries out processing so that an email is transmitted to the email address sent thereto (ACT 321).

With such configurations, the selection by the user via the UI unit 5 is no longer necessary and more customized processing can be carried out.

### APPLICATION 3 OF EXAMPLE 2

As another application example, a configuration may be considered in which a file having an extension, for example, “*.bmp” or “*.jpg” is treated as data to be printed, whereas a file having an extension for email transmission and reception tool is processed for email transmission.

In the embodiment, external transmission is assumed to be email transmission. However, the embodiment should not limit the form of transmission and other data transmission measures such as FTP may also be used.

As described above, in the embodiment, when an external storage device is connected, only a necessary hardware unit is started up in accordance with path information of a file stored in the external storage device. Thus, startup time can be reduced and power can be saved, compared with the case of starting up all the hardware units.

Path information refers to information indicating which storage area in the storage device an aggregate of data (file) is stored in. In the embodiment, path information is equivalent to the file name alone, the folder name alone, or the path name including the folder name and the file name.

In the conventional technique, since the startup of each hardware unit is started after a mode is selected by the user, there is a problem that time is required until a job is started. In the embodiment, as described above, a hardware unit that is considered necessary is started up in accordance with the folder name or the file name, for example, as in ACT 102 to ACT 105 or ACT 302 to ACT 305, before the user selects a mode. Thus, while the user is selecting the file name of a file to be printed or transmitted, startup can be carried out on the background. Therefore, stress on the user due to the startup time can be relaxed.

The processing described with reference to FIG. 4A, FIG. 4B, FIG. 6, FIG. 8A and FIG. 8B can be realized by causing the CPU 11 to execute a program stored in the FROM 13. The storage destination of the program is not limited to the FROM. For example, an HDD (hard disk drive), RAM (random access memory), ROM (read only memory), DRAM (dynamic random access memory), SRAM (static random access memory), or VRAM (video RAM) can be used.

The case where the program to execute the processing of the embodiment is recorded in advance in a storage area provided in the image forming apparatus 100 is described as an example. However, the program may be downloaded to the image forming apparatus 100 from a network, or the program stored in a computer-readable recording medium may be installed in the image forming apparatus 100. As the recording medium, any computer-readable recording medium that can store a program may be used. The recording medium may be, for example, an internal storage device that is internally provided in a computer such as ROM or RAM, a portable storage medium such as CD-ROM, flexible disk, DVD disk, magneto-optical disk or IC card, a database holding a computer program, another computer and its database, or a transmission medium on a transmission channel. The functions acquired by installation or downloading in advance may be realized in cooperation with the OS (operating system) within the apparatus. Also, at least a part of processing that is realized by the execution of a program by a CPU (central processing unit) or MPU (micro processing unit) can be executed in a circuit-based manner at an ASIC.

As described above in detail, according to the technique described in this specification, an image forming apparatus can be provided which, when an external storage device is connected, starts up only a necessary hardware unit is started up in accordance with path information of a file stored in the external storage device and therefore has a shorter startup time than in the case of starting up all the hardware units.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus comprising:
a detection unit which detects connection of an external storage device;
a determination unit which acquires path information of one or plural files in the external storage device that is detected as being connected, by the detection unit, and determines which hardware unit should be started up on the basis of the path information;
a startup unit which starts up a hardware unit corresponding to the determination by the determination unit; and
a processing execution unit which executes processing to the file, using the hardware unit started up by the startup unit.

2. The apparatus of claim 1, further comprising an interface unit which displays a list of path information of the files in the external storage device, and lets a user to select path information and processing to the path information,
wherein the startup unit starts the startup of the hardware unit corresponding to the determination by the determination unit prior to the user's selection via the interface unit.

3. The apparatus of claim 1, wherein the determination unit determines whether the path information of the file includes a predetermined folder name for printing, and thus determines whether to start up a printer unit,
the startup unit starts up the printer unit when it is determined by the determination unit that the printer unit is to be started up, and
the processing execution unit executes printing of the file using the printer unit.

4. The apparatus of claim 1, wherein the determination unit determines whether the path information of the file includes a folder name for external transmission, and thus determines whether to start up a LAN interface unit,
the startup unit starts up the LAN interface unit when it is determined by the determination unit that the LAN interface unit is to be started up, and
the processing execution unit executes external transmission of the file using the LAN interface unit.

5. The apparatus of claim 1, wherein when there is no file in the external storage device and a document is set in a scanner unit, the determination unit further determines that the scanner unit is to be started up,
the startup unit starts up the scanner unit, and
the processing execution unit scans the document using the scanner unit and stores scanned data in the external storage device.

6. The apparatus of claim 1, further comprising a folder creation unit which, when one or both of a predetermined folder name for printing and a predetermined folder name for external transmission are absent from any of the path information of the files acquired by the determination unit, creates a folder with the predetermined folder name for printing or the predetermined folder name for external transmission, in the external storage device.

7. The apparatus of claim 1, wherein the determination unit determines whether the path information of the file includes a preset print keyword designating printing, and thus determines whether to start up a printer unit,
the startup unit starts up the printer unit when it is determined by the determination unit that the printer unit is to be started up, and
the processing execution unit executes printing of the file using the printer unit.

8. The apparatus of claim 7, wherein the determination unit further acquires a parameter that designates a print condition from the file name, and
the processing execution unit executes printing based on the parameter, using the printer unit.

9. The apparatus of claim 1, wherein the determination unit determines whether the path information of the file includes a preset external transmission keyword that designates external transmission of the file, and thus determines whether to start up a LAN interface unit,
the startup unit starts up the LAN interface unit when it is determined by the determination unit that the LAN interface unit is to be started up, and
the processing execution unit executes external transmission of the file using the LAN interface unit.

10. The apparatus of claim 9, wherein the determination unit further acquires information indicating a transmission destination from the file name, and
the processing execution unit transmits the file to the transmission destination using the LAN interface unit.

11. The apparatus of claim 1, wherein the processing execution unit further changes the path information of the file or invalidates access to the file, after executing the processing to the file.

12. A processing control method comprising:
allowing an image forming apparatus
to detect connection of an external storage device;
to acquire path information of one or plural files in the external storage device that is detected as being connected;
to determine which hardware unit should be started up on the basis of the path information;
to start up a hardware unit corresponding to the determination; and
to execute processing to the file, using the hardware unit that is started.

13. The method of claim 12, wherein the image forming apparatus further displays a list of path information of the files in the external storage device, and lets a user to select path information and processing to the path information, and
in the startup, the startup of the hardware unit corresponding to the determination is started prior to the user's selection.

14. The method of claim 12, wherein in the determination, whether the path information of the file includes a predetermined folder name for printing is determined, and whether to start up a printer unit is thus determined,
in the startup, the printer unit is started up when it is determined that the printer unit is to be started up, and
in the execution of the processing, printing of the file is executed using the printer unit.

15. The method of claim 12, wherein in the determination, whether the path information of the file includes a folder name for external transmission is determined, and whether to start up a LAN interface unit is thus determined,
in the startup, the LAN interface unit is started up when it is determined that the LAN interface unit is to be started up, and
in the execution of the processing, external transmission of the file is executed using the LAN interface unit.

16. The method of claim 12, wherein when there is no file in the external storage device and a document is set in a scanner unit, the image forming apparatus further determines that the scanner unit is to be started up,
the scanner unit is started up, and
the document is scanned using the scanner unit and scanned data is stored in the external storage device.

17. The method of claim 12, wherein when one or both of a predetermined folder name for printing and a predetermined folder name for external transmission are absent from any of the path information of the acquired files, the image forming apparatus further creates a folder with the predetermined folder name for printing or the predetermined folder name for external transmission, in the external storage device.

18. The method of claim 12, wherein in the determination, whether the path information of the file includes a preset print keyword designating printing is determined, and whether to start up a printer unit is thus determined,
in the startup, the printer unit is started up when it is determined that the printer unit is to be started up, and
in the execution of the processing, printing of the file is executed using the printer unit.

19. The method of claim 12, wherein in the determination, whether the path information of the file includes a preset external transmission keyword that designates external transmission of the file is determined, and whether to start up a LAN interface unit is thus determined,
in the startup, the LAN interface unit is started up when it is determined that the LAN interface unit is to be started up, and
in the execution of the processing, external transmission of the file is executed using the LAN interface unit.

20. The method of claim 12, wherein the image forming apparatus further changes the path information of the file or invalidates access to the file, after executing the processing to the file.
